(19) United States
(12) Patent Application Publication
(10) Pub. No.: US 2013/0301995 A1
(43) Pub. Date: Nov. 14, 2013

(54) CARTRIDGE RECEPTACLE AND METHOD FOR PRODUCING THE CARTRIDGE RECEPTACLE

(71) Applicant: Alexander Thome, Essen (DE)

(72) Inventor: Alexander Thome, Essen (DE)

(73) Assignee: Euromicron Werkzeuge GmbH, Sinn-Fleisbach (DE)

(21) Appl. No.: 13/988,070

(22) PCT Filed: Nov. 18, 2011
(86) PCT No.: PCT/EP11/70469

§ 371 Date: Jul. 25, 2013

(30) Foreign Application Priority Data
Nov. 18, 2010 (DE) 10 2010 051 816.6

(51) Int. Cl. G02B 6/38

(52) U.S. Cl. CPC G02B 6/3833
USPC 385/79; 29/428

(57) ABSTRACT

A cartridge receptacle for receiving at least one cartridge, the cartridge having at least one ferrule and a lens. The receptacle includes at least one bore for receiving the cartridge and an end face on the lens side, the end face lying perpendicularly to an optical axis of the cartridge.

### CROSS-REFERENCE TO RELATED APPLICATIONS

This is a U.S. National Phase Patent Application of PCT International Patent Application Number PCT/EP2011/070469, filed Nov. 18, 2011, which claims priority benefit of German Patent No. DE 10 2010 051 816.6, filed Nov. 18, 2010, each of which is incorporated herein by reference in its entirety.

### FIELD OF THE INVENTION

The present invention relates to a cartridge receptacle, a lens connector component and a method for producing the cartridge receptacle.

### BACKGROUND OF THE INVENTION

WO 2007/119036, which is incorporated by reference, describes an optical connector for a fibre optic communication system. In this system a ferrule is glued into a housing. Until the adhesive hardens, the ferrule is freely movable in the housing. During this time the ferrule can be oriented relative to the housing.

### Problems of the Prior Art

After the ferrule is glued into the housing, the two parts must be held together until the adhesive has hardened. This production step increases the time taken for producing a connector.

### SUMMARY OF THE INVENTION

The present invention relates to a cartridge receptacle, with which ferrule and housing do not need to be held in place during a hardening process and the orientation of the cartridge can nevertheless be defined at least with respect to a part of the housing.

Described herein is a cartridge receptacle for receiving at least one cartridge, wherein the cartridge has at least one ferrule and a lens, comprising at least one bore for receiving the cartridge and an end face on the lens side, wherein the end face on the lens side is orthogonal to an optical axis of the cartridge. The end face on the lens side makes probing possible, for example in a CNC machine or a measuring machine, so that the position of the cartridge receptacle and therefore the position of the cartridge can be determined. The optical axis of the cartridge can be determined particularly easily, i.e. with simple arithmetical steps. Moreover, by means of this end face, two cartridge receptacles can be coupled together in a simple manner.

In one embodiment the cartridge is pressed or glued into the cartridge receptacle. As a result, the cartridge is in a defined position relative to the cartridge receptacle. By probing the end face, both the position of the cartridge receptacle and the position of the cartridge itself can therefore be determined reliably.

Also described herein is a lens connector component comprising the cartridge receptacle, a cartridge, a plug and a spring holder, wherein the plug has a ferrule, a ferrule holder and a spring, which fits on the ferrule holder, the ferrule is inserted into the side of the cartridge opposite the lens and the spring is compressed between the ferrule holder and the spring holder in such a way that the ferrule of the plug is pressed against the ferrule of the cartridge. As a result, the plug is held securely.

In one embodiment the lens connector component comprises a lens holder, on which the lens is fitted. As a result, the position of the lens in the lens connector component is predetermined particularly accurately.

Also described herein is a method for producing the cartridge, wherein electromagnetic radiation (light, especially white light) is coupled into the cartridge, the optical axis of the cartridge is determined and the peripheral surface of the cartridge is machined so that its central axis is parallel to the optical axis of the cartridge or identical to the optical axis of the cartridge.

The peripheral surface of the cartridge can have an incorrect angle or an incorrect positioning relative to the optical axis of the cartridge. After installation of the cartridge in the cartridge receptacle this would lead to faulty adjustment of the whole lens connector component. Such circumstances would have a negative influence on the transmission result of the whole system. In order to avoid impairment of the transmission behaviour, the incorrect positioning between peripheral surface of the cartridge and optical axis must to be corrected. For this purpose, the cartridge is clamped in a suitable device. By means of this device, any incorrect positioning that occurs is corrected. In the corrected position, the peripheral surface of the cartridge is re-machined, so that after machining, the axis of the cylindrical peripheral surface of the cartridge and the optical axis coincide. For this adjustment, a camera can be used in conjunction with suitable evaluation software. Furthermore, the use of such components allows automation of the optimization process for economical series production.

In one embodiment, before machining the peripheral surface the cartridge is clamped in an adjusting device. The adjusting device allows orientation of the cartridge in several axes. The adjusting device can be a calotte chuck or a holder for the cartridge, adjustable in several axes.

In one embodiment, during insertion of the cartridge into the cartridge receptacle, a plug, a spring holder and preferably a lens holder are also fitted, so that a lens connector component is present. The firm fixing means that particularly high precision is achieved. Preferably, after machining the peripheral surface and installation, the cartridge is not dismantled again. As a result, particularly high precision can be achieved. The lens connector components are preferably intended to be fixed in pairs in each case, with the end faces on the lens side towards each other and contiguous with one another, for joining two or more fibres together in pairs.

### BRIEF DESCRIPTION OF THE DRAWINGS

An embodiment example of the present invention is explained in more detail below, on the basis of the accompanying drawings, showing:

FIG. 1 a side view of a cartridge;

FIG. 2 a longitudinal section A-A of the cartridge shown in FIG. 1;

FIG. 3 a longitudinal section A-A of the lens connector component according to FIG. 4;

FIG. 4 a top view of the surface of a lens connector component on the lens side.

### DETAILED DESCRIPTION OF EXEMPLARY EMBODIMENTS OF THE INVENTION

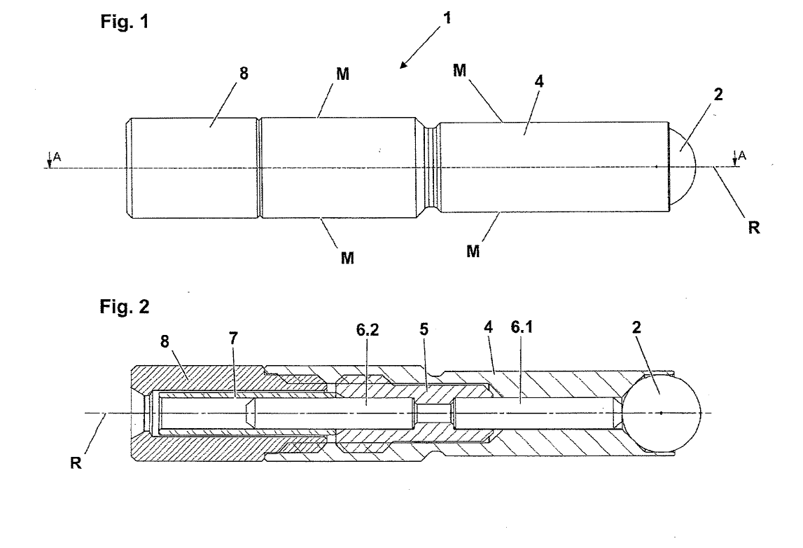

FIG. 1 shows the outer view of a cartridge 1 in a side view. The cartridge comprises a lens 2, a sleeve 4 and a screw sleeve 8. The lens 2 is arranged in an end region of sleeve 4. The screw sleeve 8 is fastened on the end of sleeve 4 opposite the lens 2.

FIG. 2 shows a longitudinal section of the cartridge shown in FIG. 1. In this view it can clearly be seen that the lens 2 is fitted in a socket that is arranged in one end of sleeve 4. A ferrule 6.1 rests on the lens 2, and is also received in the sleeve 4 and is held by a double ferrule holder 5. The double ferrule holder 5 is screwed into the sleeve 4 and in addition to the aforementioned ferrule 6.1, holds another ferrule 6.2, which extends to the other side of the double ferrule holder 5 away from the lens 2. A ceramic sleeve 7 is fitted on ferrule 6.2, forming a hollow cylinder, which is open on the side turned away from the ferrule 6.2. The screw sleeve 8 is screwed into the end of sleeve 4 opposite the lens and encloses the ceramic sleeve 7. A through-hole is provided on the front end of screw sleeve 8.

A fibre, for example a glass fibre, can be passed through the through-hole provided in the screw sleeve 8 and can be coupled to the ferrules 6.1 and 6.2. As a result, radiation, for example light, can be led from the fibre to the lens 2. The optical axis R of the cartridge is parallel to the axis of symmetry of its peripheral surface M.

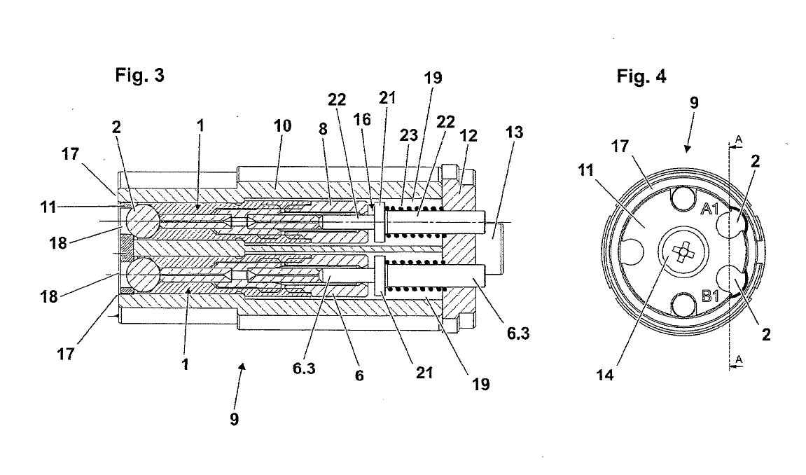

FIG. 3 shows a longitudinal section of a lens connector component 9. The lens connector component 9 has a cartridge receptacle 10, in which bores 19 for receiving cartridges, such as for example the cartridge 1 shown in FIGS. 1 and 2, are arranged. The bores are for example stepped bores as here. Two cartridges 1 of this kind are depicted in the section shown in FIG. 3. A lens holder 11 is arranged on the end of the cartridge receptacle 10 on the lens side. The lenses 2 are mounted on the lens holder 11. The lens holder 11 has several through-holes 18, which are in the positions intended for the lenses 2. The through-holes 18 are in each case dimensioned so that the lenses 2 can rest on the edge of the holes, but do not pass through. The lens holder 11 is fastened with a screw 14 on the cartridge receptacle 10. The lens connector component 9 can also be configured without a lens holder.

Each cartridge 1 is provided with a plug 16, which has a ferrule 6.3 and a ferrule holder 22 with a shoulder 21. The plug 16 passes through the hole in the screw sleeve 8 and rests on the ferrule 6.2. The ferrule holder 22 passes through a spring holder 12, which on the side of the lens connector component 9 opposite the lens is fastened on the cartridge receptacle. Springs 23 are provided on each of the ferrules 6.3, so that they rest on the shoulder 21 of the ferrule holder 22 and on the spring holder 12. The spring holder 12 is fastened with a screw 13 on the cartridge receptacle 10.

Because the spring 23 is provided, ferrule 6.3 is pressed against ferrule 6.2. In this way, reliable contact is made.

FIG. 4 shows a top view of the surface of the lens connector component 9 on the lens side. This figure clarifies how the lens holder 11 holds the lenses 2 and how it is fastened with a screw 14.

The lens connector component 9 described is used for example for connecting two or more glass fibres together in pairs. The glass fibres are received in a ferrule 6.3 of said lens connector component 9 and the two lens connector components 9 are joined together for example with a connector housing in such a way that the end faces 17 on the lens side rest on one another. Ideally the optical axes of the two cartridges 1 used, which are opposite one another, are in alignment. In order to achieve maximum possible alignment of the two optical axes, it is necessary to prepare the end faces 17 on the lens side in such a way that they make a precise 90° angle with the optical axis of the cartridge 1.

### LIST OF REFERENCE SYMBOLS

1 cartridge
2 lens
4 sleeve
5 double ferrule holder
6.1, 6.2, 6.3 ferrule
7 ceramic sleeve
8 screw sleeve
9 lens connector component
10 cartridge receptacle
11 lens holder
12 spring holder
13 screw
14 screw
16 plug
17 end face on the lens side
18 through-hole
19 bore
21 shoulder
22 ferrule holder
23 spring
R optical axis
M peripheral surface

1-7. (canceled)

8. A cartridge receptacle for receiving at least one cartridge, wherein the cartridge has at least one ferrule and a lens, comprising at least one bore for receiving the cartridge and an end face on a lens side, wherein the end face on the lens side is orthogonal to an optical axis of the cartridge.

9. A lens connector component comprising a cartridge receptacle according to claim 8, a cartridge, a plug and a spring holder, wherein the plug has a ferrule, a ferrule holder and a spring, which rests on the ferrule holder, the ferrule is inserted into a side of the cartridge opposite the lens and the spring is compressed between the ferrule holder and the spring holder in such a way that the plug is pressed against the ferrule of the cartridge.

10. A lens connector component according to claim 8, comprising a lens holder, on which the lens rests.

11. A method for producing a cartridge, wherein electromagnetic radiation is coupled into a cartridge, an optical axis of the cartridge is determined and a peripheral surface of the cartridge is machined so that it is parallel to the optical axis of the cartridge or is identical to the optical axis of the cartridge.

12. The method according to claim 11, wherein the cartridge is oriented before machining in such a way that the optical axis lies on a predetermined axis.

13. The method for producing a cartridge according to claim 11, wherein the cartridge is inserted into an adjusting device before machining the peripheral surface.

14. The method according to claim 11, wherein the cartridge is inserted into a cartridge receptacle and a plug, a spring holder and a lens holder are fitted.
